(19) United States
(12) Patent Application Publication
(10) Pub. No.: US 2026/0273967 A1
(43) Pub. Date: Sep. 17, 2026

(54) PRINTER AND INFORMATION WRITING METHOD

(71) Applicant: Masaki Okawara, Chigasaki Kanagawa (JP)

(72) Inventor: Masaki Okawara, Chigasaki Kanagawa (JP)

(73) Assignee: ETRIA Co., Ltd., Kanagawa (JP)

(21) Appl. No.: 19/450,963

(22) Filed: Jan. 16, 2026

(30) Foreign Application Priority Data
Mar. 11, 2025 (JP) 2025-038056

(51) Int. Cl. B41J 11/04; B41J 11/00; B41J 11/70; G06K 19/07

(52) U.S. Cl. CPC B41J 11/04; B41J 11/0095; B41J 11/70; G06K 19/0726; B41J 2202/30

(57) ABSTRACT

A printer includes a platen, a print head, a first antenna, a second antenna, an identification information transmitter, and a writing information transmitter. The platen conveys a paper sheet in which a radio tag is embedded. The print head prints information on the paper sheet. The first antenna is arranged upstream of the print head in a sheet conveyance direction and writes information in the radio tag. The second antenna is arranged upstream of the first antenna and writes information in the radio tag. The identification information transmitter transmits a signal to the radio tag using the second antenna, the signal containing tag identification information for discriminating the radio tag from another radio tag. The writing information transmitter transmits a signal to the radio tag using the first antenna, the signal containing the tag identification information and writing information.

### CROSS-REFERENCE TO RELATED APPLICATIONS

The present application claims priority under 35 U.S.C. § 119 to Japanese Patent Application No. 2025-038056, filed on Mar. 11, 2025. The contents of which are incorporated herein by reference in their entirety.

### BACKGROUND

### Technical Field

Embodiments described herein relate to a printer and an information writing method.

### Related Art

There is a printer such as a label printer that reads or writes information from or in a paper sheet such as a label or a tag, for example, incorporating a RFID tag (referred to as “radio tag” below) and that performs printing on the surface of the paper sheet. Such a printer, for example, writes information in each of radio tags embedded in a plurality of sequentially-arranged paper sheets and performs printing on a paper sheet in which the information has been written according to the written information.

When information is written in a radio tag, in order to write the information only in the radio tag in which the information should be written and in order not to write the information wrongly in a previous or following radio tag, the radio tag is positioned approximately right above an antenna that writes the information with the shortest distance from the antenna (referred to as “encode position” below), conveyance of the paper sheet is stopped, and the information is written in the radio tag.

On the other hand, printing of information is performed while the paper sheet incorporating the radio tag with the information written therein is being conveyed and. When printing on the paper sheet ends, the next tag is conveyed beyond the encode position.

For this reason, the information is written after the next radio tag is conveyed inversely (returned back) to the encode position and this is a factor of time-consuming writing in radio tags. Conveying the paper sheet inversely is also a factor of occurrence of a jam.

### BRIEF DESCRIPTION OF THE DRAWINGS

FIG. 1 is an outer perspective view of a printer of an embodiment;

FIG. 2 is a schematic perspective view illustrating an internal configuration of the printer;

FIG. 3 is an illustration for describing the internal configuration of the printer;

FIG. 4 is a block diagram illustrating a hardware configuration of the printer;

FIG. 5 is a block diagram illustrating a hardware configuration of a radio unit of the printer;

FIG. 6 is a memory map illustrating a writing information part;

FIG. 7 is a functional block diagram illustrating a functional configuration of the printer;

FIG. 8 is a flowchart illustrating a flow of control on the printer;

FIG. 9 is an illustration illustrating the state where a tip of a label is sensed by a label sensor;

FIG. 10 is an illustration illustrating writing of information in the radio tag performed by a second antenna;

FIG. 11 is an illustration illustrating writing of information in the radio tag performed by a first antenna;

FIG. 12 is an illustration illustrating the state where printing by a printing unit is started;

FIG. 13 is an illustration illustrating that a tip of the next label is sensed by the label sensor;

FIG. 14 is an illustration illustrating wiring of information in the next radio tag performed by the second antenna; and

FIG. 15 is an illustration illustrating the state where printing on the label ends and the label is cut.

### DETAILED DESCRIPTION

A printer according to an embodiment includes a platen, a print head, a first antenna, a second antenna, an identification information transmitter, and a writing information transmitter. The platen is configured to convey a paper sheet in which a radio tag is embedded. The print head is configured to print information on the paper sheet. The first antenna is arranged upstream of the print head in a direction of conveyance of the paper sheet, and the first antenna is configured to write information in the radio tag. The second antenna is arranged upstream of the first antenna in the direction of conveyance of the paper sheet, and the second antenna is configured to write information in the radio tag. The identification information transmitter is configured to transmit a signal to the radio tag using the second antenna, the signal containing tag identification information for discriminating the radio tag from another radio tag. The writing information transmitter is configured to transmit a signal to the radio tag using the first antenna, the signal containing the tag identification information and writing information.

An embodiment may provide a printer and an information writing method capable of writing information in a radio tag without conveying a paper sheet inversely.

Hereinafter, an example of a printer and an information writing method according to the present embodiment will be described below with reference to the accompanying drawings. Note that, in the embodiment, a label will be described as an example of a paper sheet.

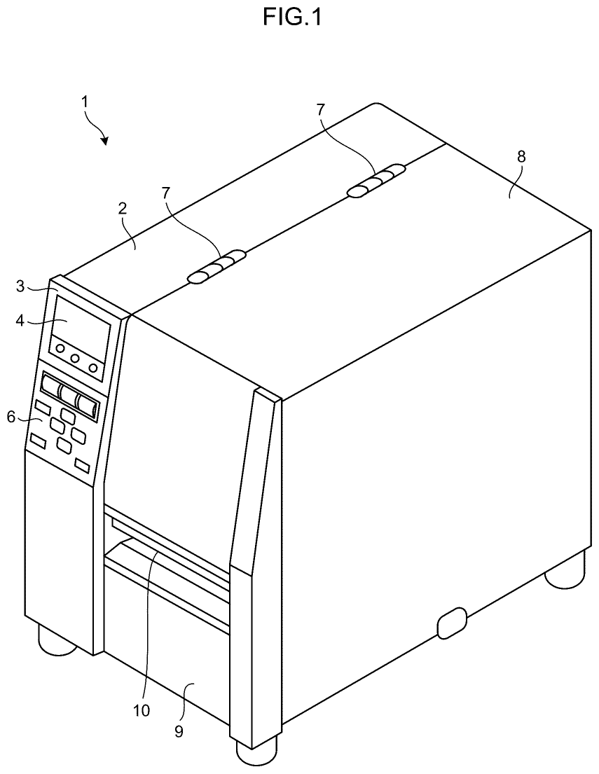

FIG. 1 is an external perspective view of a printer 1 of the embodiment. The printer 1 according to the embodiment is a label printer that prints information on a label and issues the label. The printer 1 is a printer having a function of writing information in a radio tag that is embedded in the label.

As illustrated in FIG. 1, the printer 1 includes a casing 2 located left and a casing 8 that is joined to a right side of the casing 2 with hinges 7. A front panel 3 that is formed on a front part of the casing 2 includes a display unit 4 and an operation unit 6. The display unit 4 includes a liquid crystal display with a back light; however, a display device of another type may be used.

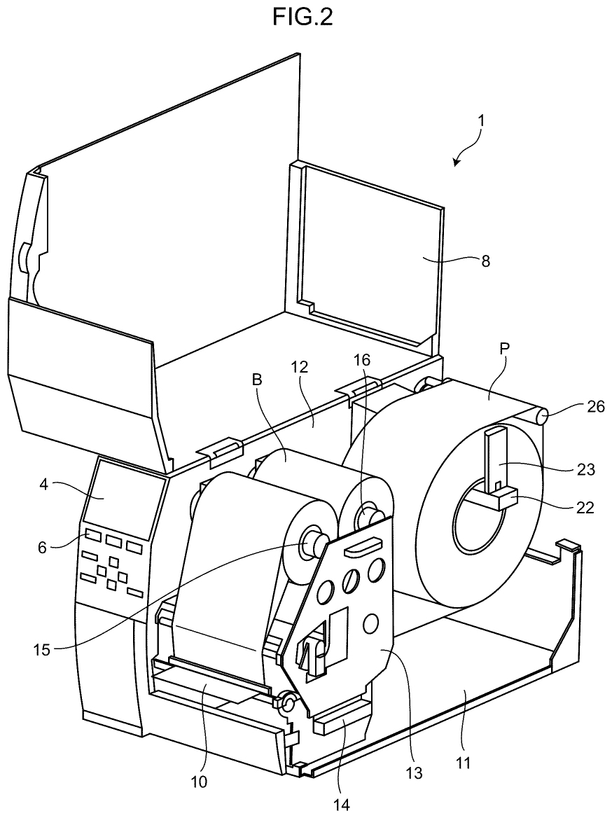

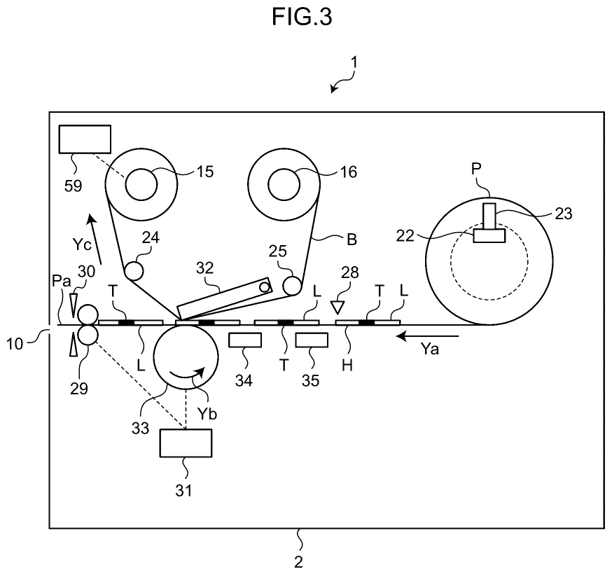

The casing 8 located right is designed to pivot upward around the hinges 7, thereby largely opening the inside of the housing (that is, the casings 2 and 8) from the side. The printer 1 is configured to be capable of holding a paper roll P that is a scroll of a plurality of labels adhered to a release liner (refer to FIG. 2). The printer 1 has a print head 32 that makes a print on a label L that is drawn from the paper roll P (refer to FIG. 3). A label issuance port 10 is formed in a front panel 9 that is provided at a front part of the casing 8. The printer 1 issues the label L with the print made by the print head 32 from the label issuance port 10.

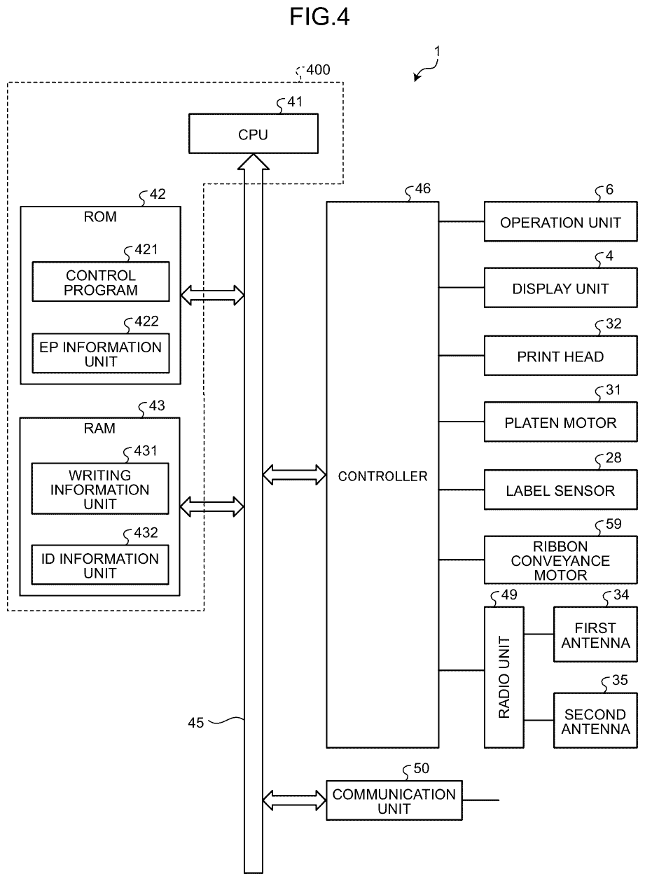

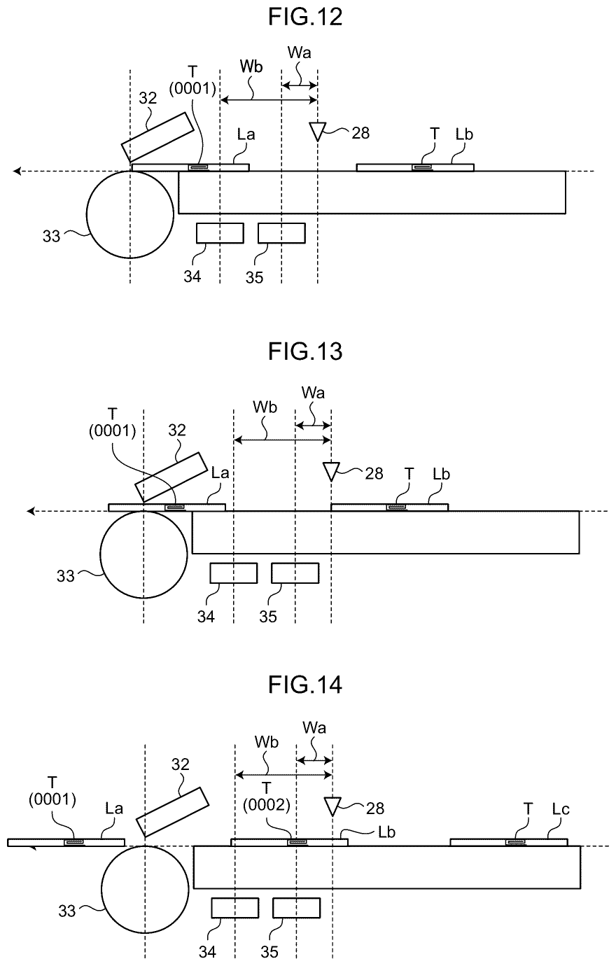

FIG. 2 is a diagram illustrating the state where the casing 8 is pivoted upward around the hinges 7, thereby opening the inside of the printer 1. As illustrated in FIG. 2, the printer 1 has a bottom surface 11. The printer 1 has a frame 12 that is on a plane and that stands on the bottom surface 11 approximately perpendicularly to the bottom surface 11. The frame 12 stands near the hinges 7 and is a platy member (partitioner) that partitions a mechanical unit and a control unit. The mechanical unit (front side with respect to the frame 12 in FIG. 2) includes a driving shaft 15, a driven shaft 16, and a support shaft 22. In the control unit (back side with respect to the frame 12 in FIG. 12), there are arranged a control unit (refer to FIG. 4) such as a microprocessor for controlling the printer 1 and a power unit (not illustrated in the drawings).

The driven shaft 16 is a shaft on which an ink ribbon B with thermo-sensitive ink applied thereto is mounted and that axially supports the ink ribbon B. A ribbon conveyance motor 59 (refer to FIG. 3) drives the driving shaft 15 and thus the driving shaft 15 rotates. The driving shaft 15 is a shaft for, by rotating, drawing the ink ribbon B mounted on the driven shaft 16 and reeling in the ribbon B. Each of the driving shaft 15 and the driven shaft 16 is mounted on the frame 12 in a cantilever manner. In other words, the ink ribbon B is mounted by being fitting onto the driven shaft 16 on a side opposite to the frame 12. A plate 13 pivotally mounted on a pivot shaft 14 is turned over and the ink ribbon B is fitted onto the driven shaft 16 and then the plate 13 is brought back. The ink ribbon B is mounted onto the driven shaft 16 in this manner so that the ink ribbon B is mounted such that the ink ribbon B does not drop off the driven shaft 16.

Furthermore, the support shaft 22 is mounted on a back part of the printer 1. The support shaft 22 is a shaft that axially supports the paper roll P with the labels L adhered thereto such that the paper roll P is rotatable. The support shaft 22 is mounted on the frame 12 in a cantilever manner. In other words, the paper roll P is mounted in a way that the paper roll P is fitted onto the support shaft 22 from the side opposite to the frame 12. The paper roll P mounted on the support shaft 22 is axially supported by the support shaft 22 such that the paper roll P is rotatable.

A back-side guide (not illustrated in the drawings) and a front-side guide 23 are mounted on the support shaft 22. The back-side guide is set on the support shaft 22 closer to the frame 12. The front-side guide 23 is set on the support shaft 22 farther away from the frame 12. The back-side guide and the front-side guide 23 are movable along the support shaft 22 in a direction in which the backside-guide and the front-side guide 23 go away from and come closer to each other and a rack-and-pinion not illustrated in the drawings performs positioning of a center part of the mounted paper roll P in a width direction. Regardless whether the paper roll P is wide or narrow, the center part of the paper roll P in the width direction is positioned in the same position.

A damper 26 is mounted on the frame 12. The damper 26 is a structure that has an elongated and approximately cylindrical shape and that deflects (or moves elastically) in one direction when a force is applied thereto. The release liner right after being drawn from the paper roll P is hung over the damper 26, and the damper 26 deflects and thus attenuates a shock on the paper roll P caused by a tension of the release liner occurring in the case where conveyance of the release liner is started for printing on the label L, or the like.

A configuration of the printer 1 for printing on the label L and a configuration of the printer 1 for writing information in a radio tag T will be described from here. FIG. 3 is an illustration for describing an internal configuration of the printer 1.

As illustrated in FIG. 3, the paper roll P is supported on and is mounted on the support shaft 22 and is rotatably fixed by the front-side guide 23. The labels L are adhered to the paper roll P at given intervals. A radio tag T is embedded in each of the labels L. The label L is formed such that printing can be performed on the surface of the label L. The radio tag T is an integrated circuit (IC) that has an antenna not illustrated in the drawings and that stores information that is received by the antenna.

In the printer 1, the print head 32 (printing unit) and a cylindrical platen 33 (conveyance unit) are arranged to face each other. The print head 32 is a thermal head in which, for example, a heating element that applies heat to perform printing is arranged linearly. The print head 32 elastically exerts a force to the platen 33 and is pressed against an outer circumference of the platen 33. A platen motor 31 causes the platen 33 to rotate in a direction of an arrow Yb.

The print head 32 and the platen 33 hold, in between, a release liner Pa that has the labels L adhered thereto and that is drawn from the outermost circumference of the paper roll P and that is conveyed on a conveyance path H. The platen 33 rotates in the direction of the arrow Yb and thereby conveys the release liner Pa held between the print head 32 and the platen 33. In other words, rotation of the platen 33 in the direction of the arrow Yb conveys the label L incorporating the radio tag T in the direction of the arrow Ya (from the right to the left in FIG. 3).

An outer circumferential part of the ink ribbon B mounted on the driven shaft 16 is drawn and is held by the print head 32 and the platen 33 in between via a guide 25 and is wound around the driving shaft 15 via a guide 24. The ribbon conveyance motor 59 causes the driving shaft 15 to rotate and accordingly the ink ribbon B is conveyed in a direction of an arrow Yc. The ink of the ink ribbon B held between the print head 32 and the platen 33 melts with application of heat by the print head 32 and is transferred onto a surface (printing surface) of the label L, so that information is printed on the surface. The ink ribbon B is wound at approximately the same speed as the speed of conveyance of the label L and thus is conveyed together with the label L.

The label L and the release liner Pa that are conveyed by the platen 33 are further conveyed by a conveyance roller 29, is cut by a cutter 30, and is issued from the label issuance port 10. The platen motor 31 causes the conveyance roller 29 to rotate and thereby the conveyance roller 29 conveys the label L and the release liner Pa in a direction to the label issuance port 10.

The printer 1 also includes a first antenna 34 and a second antenna 35 by the conveyance path H. The first antenna 34 is provided near and upstream of the print head 32 in the direction of conveyance of the label L. The first antenna 34 transmits a signal for writing information in a radio tag T that is embedded in a label L positioned in the vicinity of the first antenna 34 including a position substantially immediately above the first antenna 34 (sometimes referred to as encode position (EP)). The first antenna 34 receives a signal that contains information stored in the radio tag T and that is transmitted from the radio tag T embedded in the label L positioned in the vicinity of the first antenna 34. The information that is transmitted by the first antenna 34 for writing in the radio tag T is, for example, information to be printed on the label L in which the radio tag T is embedded (for example, information on an item on which the label L is to be adhered) and is, for example, a price of the item, a name of the item, and an item code that specifies the item.

The second antenna 35 is provided upstream of the first antenna 31 in the direction of conveyance of the label L, a little (for example, four to five centimeters) away from the first antenna 31. The second antenna 35 transmits a signal for writing information in a radio tag T embedded in a label L positioned in an EP of the second antenna 35. The second antenna 35 receives a signal that contains information stored in the radio tag T and that is transmitted from the radio tag T embedded in the label L positioned in the EP of the second antenna 35.

The second antenna 35 is an antenna having higher directionality than the first antenna 34 (that is, an antenna that transmits a signal within a narrow area in a given direction) and causes information to be written in only the radio tag T positioned in the EP of the second antenna 35. It is preferable that isolation in the vicinity of the second antenna 35 be increased to enable the second antenna 35 to transmit a signal to only the radio tag T positioned in the EP (that is, such that the signal is not leaked to another radio tag T). In other words, the first antenna 34 is an antenna having lower directionality than the second antenna 35 (that is, the first antenna 34 is an antenna capable of transmitting a signal within a wider area than the second antenna 35) and is able to transmit a signal to a radio tag T positioned in a position in a wide area to some extent containing the EP of the first antenna 34. By increasing and reducing the intensity of the signal that is transmitted from the first antenna 34 makes it possible to adjust the area of the wide area. In other words, increasing the intensity of the signal transmitted from the first antenna 34 makes it possible to increase the area of the wide area and reducing the intensity of the signal transmitted from the first antenna 34 makes it possible to narrow the area of the wide area.

The information that the second antenna 35 transmits for writing in the radio tag T is tag identification information for discriminating the radio tag T on which writing is performed from another radio tag T. The tag identification information is numerical information (increment information) obtained by making an increment of a given number (for example, +1) each time. The second antenna 35 transmits increment information such as “0001”, “0002”, and “0003” (referred to as “ID” below) sequentially to radio tags T that are conveyed to the EP. In other words, a signal containing information of “0001” as an ID is transmitted from the second antenna 35 to a radio tag T that is conveyed to the EP firstly and a signal containing information of “0002” as an ID is transmitted from the second antenna 35 to another radio tag T that is conveyed to the EP next. In other words, increment information such as “0001”, “0002”, and “0003”, that is, identification information for discriminating each of the radio tags T from another is written in the radio tag T.

The printer 1 also includes a label sensor 28 by the conveyance path H. The label sensor 28 is, for example, an optical sensor and is, for example, a permeative optical sensor. The label sensor 28 is set in the vicinity of the second antenna 35 (upstream of the second antenna 35 in the direction of conveyance of the label L). The label sensor 28 senses a leading end of the label L that gets closer to the second antenna 35. By conveying the label L by only a second give distance after the label sensor 28 senses the leading end of the label L, the printer 1 is able to position the radio tag T embedded in the label L at the EP for the second antenna 35.

When the label sensor 28 senses the leading end of the label L, the printer 1 conveys the label L by only the second given distance and positions the radio rag T embedded in the label L in the EP of the second antenna 35. The second antenna 35 transmits a signal containing an ID for writing in the radio tag T positioned in the EP. In this case, because the second antenna 35 has high directionality, the signal does not reach radio tags T preceding and following the radio tag T.

When the label sensor 28 senses a leading-end position of a label L, the printer 1 conveys the label L in which an ID is written by the second antenna 35 to a position with a first given distance from the label sensor 28 and positions the radio tag T embedded in the label L in a position in the vicinity of the EP of the first antenna 34. The first antenna 34 then transmits writing information for writing in the radio tag T positioned in the vicinity of the EP. The first antenna 34 transmits the writing information together with an ID that identifies (specifies) a radio tag in which the writing information is to be written. In this case, the first antenna 34 has low directionality and thus there is a possibility that the transmitted ID will reach a radio tag preceding or following the radio tag T. The first antenna 34 however transmits the writing information together with the ID that identifies (specifies) the radio tag T in which the writing information is written. Therefore, when a radio tag T receives its ID, the radio tag T writes the received writing information, while when a radio tag T receives an ID other than its ID, the radio tag T does not write the received writing information. In this manner, the writing information that is transmitted from the first antenna 34 is written in only the specific radio tag T.

Note that the first distance by which a label L is conveyed is practically a distance from the position of the label sensor 28 to the position of the said label L at the time when printing on a label L preceding the said label L ends and the preceding label L is cut. Thus, the radio tag T embedded in the label L having moved by the first distance is not necessarily positioned at the EP of the first antenna 34 and sometimes is positioned a little beyond the EP of the first antenna 34. Even in such a case, the label L is positioned in the vicinity of the EP of the first antenna 34.

Hardware of the printer 1 will be described from here. FIG. 4 is a block diagram illustrating a hardware configuration of the printer 1. As illustrated in FIG. 4, the printer 1 includes a central processing unit (CPU) 41 that is an example of a processor, a read only memory (ROM) 42, and a random access memory (RAM) 43. The CPU 41 is a main controller. The ROM 42 stores various types of programs for controlling the printer 1. The printer 1 may include an HDD and an SSD instead of the ROM 42. Programs and various types of data are loaded into the RAM 43. The CPU 41, the ROM 42, and the RAM 43 are connected to one another via a bus 45. A control unit 400 is configured with the CPU 41, the ROM 42, and the RAM 43. In other words, the CPU 41 operates according to a control program that is stored in the ROM 42 and then is loaded into the RAM 43 and accordingly the control unit 400 executes a process of controlling the printer 1 to be described below.

The ROM 42 includes a control program part 421 and an EP information part 422. The control program part 421 stores the control program for controlling the printer 1. The EP information part 422 stores the first given distance and the second given distance. Note that, because the first given distance and the second given distance differ depending on the type of the label L, it is preferable that the first given distance and the second given distance corresponding to the label L to be used are specifiable according to the type of the label L.

The RAM 43 includes a writing information part 431 (storage unit) and an ID information part 432. The writing information part 431 stores writing information to be written in the radio tag T according to the ID and printing information. The writing information part 431 will be described below using FIG. 6. The ID information part 432 stores an ID for writing in a radio tag T that is positioned in the EP of the second antenna 35. As for the ID stored in the ID information part 432, an ID for writing in a radio TAG T that is conveyed to the position of the EP next. In other words, as for the ID stored in the ID information part 432, the latest ID obtained by making an increment on the ID that is written in the preceding radio tag T is stored.

The control unit 400 is connected to the operation unit 6, the display unit 4, the print head 32, the platen motor 31, the label sensor 28, the ribbon conveyance motor 59, and a radio unit 49 via the bus 45 and a controller 46. The operation unit 6 is an operator (for example, keys) that an operating person who operates the printer 1 operates. The display unit 4 is, for example, a liquid crystal display unit and displays information to the operating person who operates the printer 1. The print head 32 is, for example, a thermal head that melts the ink ribbon B by heat generated by a heating element and makes a print on the label L. The platen motor 31 is a drive source (for example, motor) that causes the platen 33 to rotate. The label sensor 28 senses a leading end of the label L getting closer to the second antenna 35. The ribbon conveyance motor 59 is a drive source that causes the driving shaft 15 to rotate (for example, a motor).

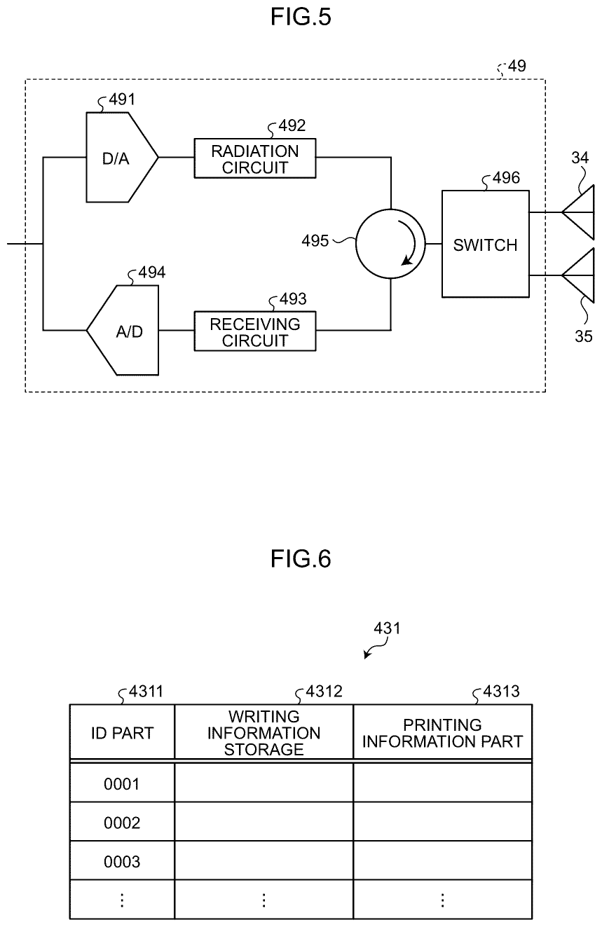

The radio unit 49 is a transmitter-receiver circuit for causing the first antenna 34 and the second antenna 35 to transmit signals and to process signals that are received by the first antenna 34 and the second antenna 35. The first antenna 34 and the second antenna 35 are connected to the radio unit 49. The radio unit 49 will be described below using FIG. 5. The first antenna 34 transmits an ID and writing information to a radio tag T positioned in the vicinity of the EP for the first antenna 34. The first antenna 34 has low directionality and transmits a signal in a wide area. The second antenna 35 transmits an ID for writing in a radio tag T positioned in the EP for the second antenna 35 to the radio tag T. The second antenna 35 has high directionality and transmits a signal to only the radio tag T positioned in the EP.

On receiving an instruction from the control unit 400, the controller 46 controls the operation unit 6, the display unit 4, the print head 32, the platen motor 31, the label sensor 28, the ribbon conveyance motor 59, and the radio unit 49. For convenience of description, control performed by the controller 46 will be described as control performed by the control unit 400 below.

The control unit 400 is connected to a communication unit 50 via the bus 45. The communication unit 50 is connected to an information processing apparatus that transmits writing information and printing information to the printer 1 via a communication line such as a local area network (LAN) such that communications are enabled therebetween.

The radio unit 49 will be described next. FIG. 5 is a block diagram illustrating a configuration of the radio unit 49 of the printer 1. As illustrated in FIG. 5, the radio unit 49 includes a D/A converter 491, a radiation circuit 492, a receiving circuit 493, an A/D converter 494, a transmission-reception switch 495, and a switch 496 (selector).

The D/A converter 491 performs D/A conversion on information for transmission from the control unit 400 and supplies the converted information to the radiation circuit 492. The radiation circuit 492 performs given modulation on the input information, adjusts an output power, and outputs a transmission signal obtained by the modulation to the switch 496 via the transmission-reception switch 495 that switches between transmission and reception. The switch 496 selects the first antenna 34 or the second antenna 35 and outputs a signal to the selected antenna. On the other hand, a response signal (signal) from the radio tag T that is received by the first antenna 34 or the second antenna 35 is supplied to the receiving circuit 493 via the switch 496 and the transmission-reception switch 495. The receiving circuit 493 demodulates the response signal and the A/D converter 494 performs A/D conversion on the demodulated response signal and passes the converted signal to the control unit 400.

The writing information part 431 (storage) will be described next. FIG. 6 is a memory map illustrating the writing information part 431. As illustrated in FIG. 6, the writing information part 431 has an ID part 4311, a writing information storage 4312, and a printing information part 4313. The ID part 4311 stores an ID for identifying a radio tag T. The writing information storage 4312 stores wiring information in association with an ID stored in the ID part 4311, the writing information being information to be written in a radio tag T that is identified by the ID. The printing information part 4313 stores printing information in association with an ID stored in the ID part 4311, the printing information being information to be printed on a label L in which a radio tag T identified by the ID is embedded.

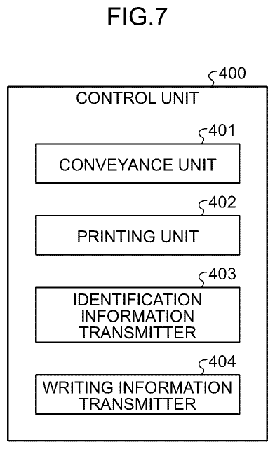

A functional configuration of the printer 1 according to the embodiment will be described from here. FIG. 7 is a functional block diagram illustrating a functional configuration of the printer 1. The control unit 400 functions as a conveyance unit 401, a printing unit 402, an identification information transmitter 403, and a writing information transmitter 404 according to the control program stored in the control program part 421 of the ROM 42.

The conveyance unit 401 conveys a label L in which a radio tag T is embedded. Specifically, the conveyance unit 401 conveys the label L with the radio tag T embedded therein by causing the platen 33 to rotate. Furthermore, specifically, by driving the platen motor 31 to cause the platen 33 to rotate, the conveyance unit 401 conveys the label L with the radio tag T embedded therein.

The printing unit 402 prints information on the label L. Specifically, by driving the print head 32, the printing unit 402 prints on the label L printing information for the writing information transmitted. After the first antenna 34 transmits the writing information to the radio tag T, the printing unit 402 prints the printing information on the label L incorporating the radio Tag T.

Using the second antenna 35, the identification information transmitter 403 transmits, to the radio tag T, a signal containing tag identification information for discriminating the radio tag T from another radio tag T. Specifically, using the second antenna 35, the identification information transmitter 403 transmits, to the radio tag T, a signal containing increment information for discriminating the radio tag T from another radio tag T. More specifically, using the second antenna 35, the identification information transmitter 403 transmits, to the radio tag T positioned in the EP, a signal for writing the increment information for discriminating the radio tag T from another radio tag T.

Using the first antenna 34, the writing information transmitter 404 transmits, to the radio tag T, a signal containing writing information containing the tag identification information. Specifically, using the first antenna 34, the writing information transmitter 404 transmits, to the radio tag T, writing information containing tag identification information for discriminating the radio tag T from another radio tag T. For example, using the first antenna 34, the writing information transmitter 404 transmits a signal to the radio tag T, the signal for specifying tag identification information for discriminating the radio tag T from another radio tag T using a select command and for writing in the radio tag T.

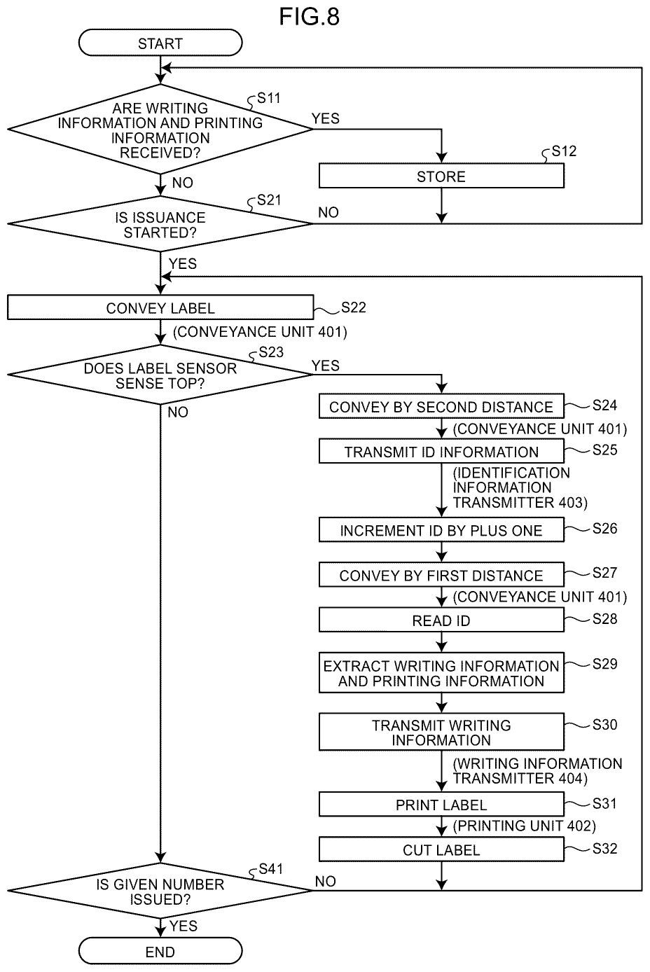

Control on the printer 1 will be described from here. FIG. 8 is a flowchart illustrating a flow of control on the printer 1. The printer 1 receives, together with an ID for identifying a radio tag T, writing information to be written to the radio tag T, which is embedded in a label L to be issued, and printing information to be printed on the label L previously from the information processing apparatus. Specifically, as illustrated in FIG. 8, the control unit 400 of the printer 1, for example, determines whether writing information and printing information are received together with an ID from the information processing apparatus to which the printer 1 is connected (S11). When it is determined that writing information and printing information are received together with an ID (Yes at S11), the control unit 400 stores the received ID in the ID part 4311 and stores, in association with the ID, the received writing information in the writing information storage 4312 and the received printing information in the printing information part 4313 (S12). The control unit 400 then returns to S11.

When it is determined that it is not reception of an ID, writing information, and printing information (NO at S11), the control unit 400 determines whether or not an instruction to issue a label L has been made, for example, by operating a button (not illustrated in the drawings) for issuing a label L, or the like (S21). When it is determined that no instruction to issue a label L has been made (No at S21), the control unit 400 returns to S11 and, when it is determined that an instruction to issue a label L has been made (YES at S21), the conveyance unit 401 conveys the label L adhered to the release liner Pa in the direction of the arrow Ya (S22).

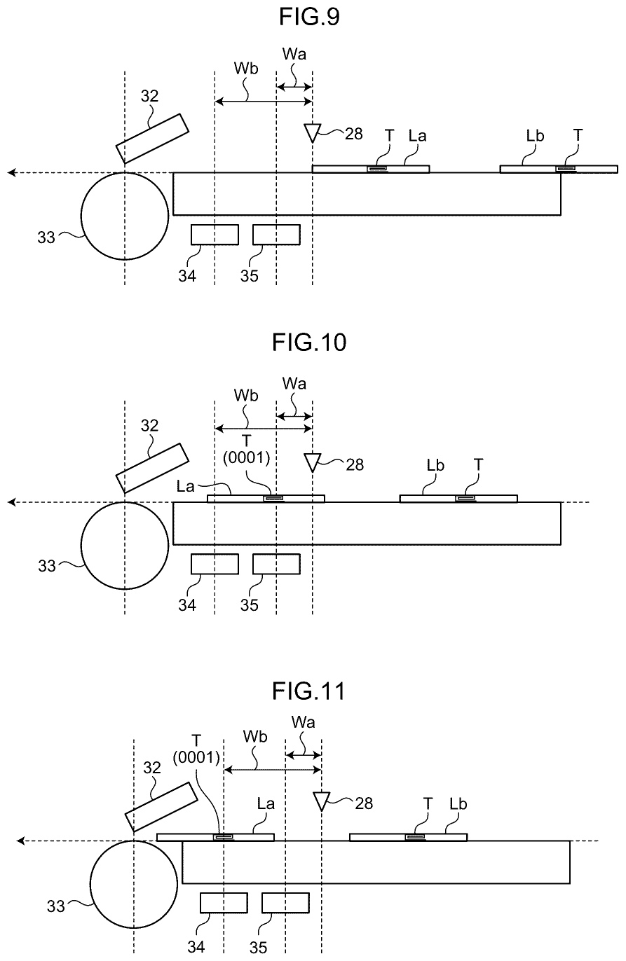

Next, the control unit 400 determines whether or not the label sensor 28 senses a leading end of the label L (S23). FIG. 9 is a diagram illustrating the state where the label sensor 28 senses the leading end of the label L. As illustrated in FIG. 9, the label sensor 28 is set upstream of the second antenna 35 in the direction of conveyance of the label L. The distance from the label sensor 28 to the EP of the second antenna 35 is Wa. In other words, the second given distance is Wa. The distance from the label sensor 28 to the vicinity of the EP of the first antenna 34 is Wb. In other words, the first distance is Wb. In FIG. 9, the label sensor 28 senses a leading end position of a label L (this label L is referred to as “label La”).

Back to the description of FIG. 8. When it is determined that the label sensor 28 has sensed the leading end of the label La (YES at S23), the conveyance unit 401 conveys the release liner Pa and the label La by the second distance Wa (S24). FIG. 10 is a diagram of the state where the label La is conveyed from the position of the label sensor 28 by only the second given distance Wa. As illustrated in FIG. 10, a radio tag T that is embedded in the label La that is conveyed by only the second distance Wa is positioned in the EP of the second antenna 35. For this reason, the second antenna 35 is able to write information in the radio tag T. Note that, in the state in FIG. 10, because a label Lb following the label La is not positioned in the EP of the second antenna 35, the second antenna 35 is unable to write information in the radio tag T embedded in the label Lb.

Back to description of FIG. 8. Next, the identification information transmitter 403 transmits a signal containing an ID (for example, “0001”) stored in the ID information part 432 from the second antenna 35 (S25). The radio tag T positioned in the EP of the second antenna 35 and embedded in the label La receives the ID and stores the ID in the storage (not illustrated in the drawings) of the radio tag T itself. In FIG. 10, the radio tag T receives the ID “0001” and stores the ID.

Back to the description of FIG. 8. Next, the control unit 400 makes an increment on the ID that is stored in the ID information part 432 (for example, “0002” obtained by making an increment of +1) (S26).

Next, the conveyance unit 401 conveys the release liner Pa and the label La to the position the first given distance Wb ahead from the position of the label sensor 28 (S27). FIG. 11 is a diagram of the state where the label La is conveyed from the position of the label sensor 28 by only the first distance Wb. As illustrated in FIG. 11, when the label La that is conveyed to the position the first given distance Wb ahead from the position of the label sensor 28, the label La is positioned in the vicinity of the EP of the first antenna 34. For this reason, the first antenna 34 is able to read information stored in the radio tag T embedded in the label La. The first antenna 34 is able to write information in the radio tag T embedded in the label La.

In the state in FIG. 11, the label La only has to be positioned in the vicinity of the EP of the first antenna 34. In other words, because the position in which printing on and cutting the previous label L end corresponds to the first given distance Wb, the label La sometimes may be in a position shifted more or less forward or backward from the position of the EP of the first antenna 34. Even in such a case, because the first antenna 34 has low directionality and transmits a signal in a wide area, the first antenna 34 is able to read information from the radio tag T positioned in the vicinity of the EP and deliver a signal to the radio tag T. Furthermore, increasing outputs of signals to be written and read by the first antenna 34 enables information stored in the radio tag T to be read more assuredly and enables a signal for writing information in the radio tag T to be received by the radio tag T more assuredly.

Back to the description of FIG. 8. Next, the control unit 400 reads the ID stored in the radio tag T (S28). In the example in FIG. 11, “0001” is read as the ID. The writing information transmitter 404 searches the ID part 4311 based on the read ID, reads writing information corresponding to the ID from the writing information storage 4312 (S29), and reads printing information corresponding to the ID from the printing information part 4313 (S29).

Next, the writing information transmitter 404 transmits a signal containing the ID read at S28 and the read writing information from the first antenna 34 (S30). In the state in FIG. 11, a signal containing the ID read at S28 and the read writing information is transmitted from the first antenna 34. The wireless tag T, which is embedded in the label La and has the ID “0001”, stores the received writing information because the received ID and the ID stored in itself are matched. When the first antenna 34 transmits a signal in a wide area or when the output of the signal from the first antenna 34 is increased, the signal from the first antenna 34 may reach another radio tag T embedded in a label L other than the label La. In this case, because any label L other than the label La stores an ID excluding the ID “0001” and thus its ID is different from the ID “0001” transmitted at S30, any other radio tags T do not store the received writing information. In other words, because the writing information transmitter 404 transmits a signal containing both an ID and writing information, and the writing information is not stored in any radio tag T having an ID unmatched.

Back to the description of FIG. 8. Next, the printing unit 402 performs printing on the label L conveyed to the printing position based on the printing information that is read at S29 (S31). FIG. 12 is a diagram illustrating the state where printing is performed on the label L at S31. FIG. 13 is a diagram illustrating the state where the label sensor 28 senses a leading end position of the next label L (label Lb).

FIG. 14 is a diagram of the state where the label Lb is conveyed by only the second distance Wa from the position of the label sensor 28. As illustrated in FIG. 14, when the label Lb is conveyed only the second distance Wa, the label Lb is positioned in the EP of the second antenna 35. For this reason, the second antenna 35 is able to write information in the radio tag T that is embedded in the label Lb. Note that, in the state in FIG. 14, because a label Lc following the label Lb is not positioned in the EP of the second antenna 35, the second antenna 35 is unable to write information in the radio tag T embedded in the label Lc. The example in FIG. 14 represents the state where the second antenna 35 has written an ID “0002” in the radio tag T embedded in the label Lb.

Back to description of FIG. 8. Next, the control unit 400 conveys the label La with the print thereon to a position of the cutter 30 and cuts the label La together with the release linear Pa (that is, issues the label L) (S32). The control unit 400 then returns to S22.

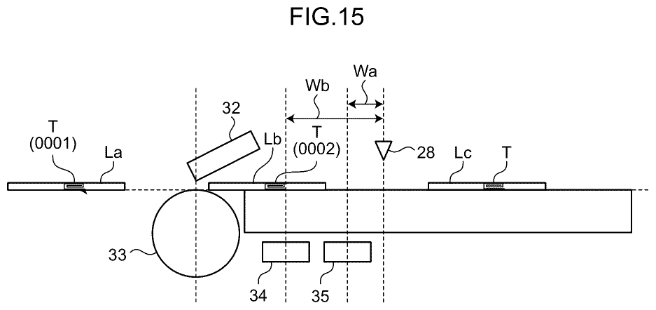

FIG. 15 is a diagram illustrating the state where the label La is cut. In this state, the radio tag T embedded in the next label Lb is in a position slightly shifted from the EP of the first antenna 34 (position in the vicinity of the EP). In such a case, because the first antenna 34 is an antenna that transmits a signal in a wide area, the first antenna 34 allows a signal for reading an ID and a signal containing writing information to reach the radio tag T slightly shifted from the EP. Furthermore, increasing the output of the signal transmitted from the first antenna 34 further enables the signal containing the writing information to reach the radio tag T. In this case, there is a possibility that the signal will reach another label L; however, because the writing information is transmitted together with the ID, it is possible to write the writing information only in the radio tag T having the matched ID.

Note that, when the label sensor 28 senses a leading-end position of a label L and then the label sensor 28 senses a leading-end position of the next label L during execution of the process from S24 to S32 on the label L, the control unit 400 performs the process of S24 to S32 on the next label L in parallel with the process on the label L.

Back to description of FIG. 8. When it is determined that the label sensor 28 does not sense the leading end of the label L (NO at S23), the control unit 400 determines whether a specified number of labels L have been issued (S41). When it is determined that the specified number of labels have not been issued, back to S22 and, when it is determined that the specified number of labels L have been issued (YES at S41), the control unit 400 ends the process.

As described above, the printer 1 of the embodiment includes the conveyance unit 401 that conveys a label L in which a radio tag T is embedded, the printing unit 402 that prints information on the label L, the first antenna 34 that is arranged upstream side of the printing unit 402 in a direction of conveyance of the label L and that writes information in the radio tag T, the second antenna 35 that is arranged upstream of the first antenna 34 in the direction of conveyance of the label L and that writes information in the radio tag T, the identification information transmitter 403 that, using the second antenna 35, transmits a signal containing increment information for discriminating the radio tag T from another radio tag T to the radio tag T, and the writing information transmitter 404 that, using the first antenna 34, transmits a signal containing increment information and writing information to the radio tag.

The printer 1 of the embodiment transmits the increment information to the radio tag T using the second antenna 35 and transmits the signal containing the increment information and the writing information to the radio tag T using the first antenna 34 and therefore, even when the radio tag T is in a position shifted from the encode position for the first antenna 34, it is possible to write the writing information in only the radio tag having the matched ID. Thus, it is possible to write the information in the radio tag T without conveying the label L inversely to the encode position of the first antenna 34. Accordingly, it is possible to shorten a time required for writing in the radio tag. It is also possible to prevent the label L from being jammed due to inverse conveyance of the label L.

The embodiment of the present embodiment has been described; however, the embodiment is presented as an example and is not intended to limit the scope of the disclosure. This new embodiment can be carried out in various modes and various omissions, replacements, changes can be made within a range without deviation from the scope of the disclosure. The embodiment and modifications are covered by the scope and summary of the disclosure and are covered by the scope of the disclosure described in the claims and equivalences thereof.

For example, in the embodiment, a number obtained by making an increment by +1 on a numerical value each time is described as an example of the increment information; however, the increment information is not limited to this and, for example, an increase may be made by a numerical value other than +1.

In the embodiment, the label L is described as an example of a paper sheet. The paper sheet however is not limited to this and, for example, the paper sheet may be a tag to be fixed on clothing, or the like.

In the embodiment, as illustrated in FIG. 6, there are stored, in association with an ID, writing information to be written in a radio tag T having the ID and printing information to be printed on a label L. The information however is not limited to this and, for example, writing information associated with an ID may be received on the ID basis from the information processing apparatus every time a label L is issued.

The followings are noted.

The increment information may be a number.

The storage may store a piece of printing information related to a piece of writing information in association with each piece of increment information.

The first antenna may be an antenna having low directionality and the second antenna may be an antenna having high directionality.

The writing information transmitter may read a piece of increment information stored in the radio tag, read a piece of writing information associated with the read piece of increment information from the storage, and transmit the read piece of writing information.

The paper sheet may be a label in which the radio tag is embedded.

The printer may further include a sensor that is arranged upstream of the second antenna in the direction of conveyance of the paper sheet, the sensor configured to sense an end of the paper sheet. When the sensor senses the end of the paper sheet and the paper sheet is conveyed by the platen a second given distance after the sensor senses the end of the paper sheet, the identification information transmitter may transmit the signal containing the tag identification information.

The printer may further include a cutter configured to cut the paper sheet on which the information has been printed by the print head.

The printer may further include a selector configured to select either the first antenna or the second antenna.

Any of the above-described apparatus, devices or units can be implemented as a hardware apparatus, such as a special-purpose circuit or device, or as a hardware/software combination, such as a processor executing a software program.

Further, as described above, any one of the above-described and other methods may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Each of the functions of the described embodiments, and any one of the above-described and other methods may be implemented by one or more processing circuits or circuitry. Processing circuitry includes a programmed processor, as a processor includes circuitry. A processing circuit includes devices such as an application specific integrated circuit (ASIC), digital signal processor (DSP), field programmable gate array (FPGA) and conventional circuit components arranged to perform the recited functions.

As used herein, the singular forms “a”, “an” and “the” are intended to include the plural forms as well, unless the context clearly indicates otherwise.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer comprising:
a platen configured to convey a paper sheet in which a radio tag is embedded;
a print head configured to print information on the paper sheet;
a first antenna that is arranged upstream of the print head in a direction of conveyance of the paper sheet, the first antenna configured to write information in the radio tag;
a second antenna that is arranged upstream of the first antenna in the direction of conveyance of the paper sheet, the second antenna configured to write information in the radio tag;
an identification information transmitter configured to transmit a signal to the radio tag using the second antenna, the signal containing tag identification information for discriminating the radio tag from another radio tag; and
a writing information transmitter configured to transmit a signal to the radio tag using the first antenna, the signal containing the tag identification information and writing information.

2. The printer according to claim 1, wherein the identification information transmitter is configured to transmit, as the tag identification information, increment information for identifying the radio tag individually.

3. The printer according to claim 1, wherein the first antenna is configured to transmit a signal in a wider area than the second antenna.

4. The printer according to claim 2, further comprising a storage that stores a piece of writing information in association with each piece of increment information, the piece of writing information to be written in a radio tag in which the associated piece of increment information is written.

5. The printer according to claim 1, wherein the writing information transmitter is configured to specify the radio tag with the tag identification information and transmit the writing information to the radio tag using the first antenna.

6. The printer according to claim 1, wherein, after the writing information is transmitted to the radio tag using the first antenna, the print head is configured to print information on the paper sheet in which the radio tag is embedded.

7. The printer according to claim 2, wherein the increment information is a number.

8. The printer according to claim 4, wherein the storage is configured to store a piece of printing information related to a piece of writing information in association with each piece of increment information.

9. The printer according to claim 3, wherein the first antenna is an antenna having low directionality and the second antenna is an antenna having high directionality.

10. The printer according to claim 4, wherein the writing information transmitter is configured to read a piece of increment information stored in the radio tag, read a piece of writing information associated with the read piece of increment information from the storage, and transmit the read piece of writing information.

11. The printer according to claim 1, wherein the paper sheet is a label in which the radio tag is embedded.

12. The printer according to claim 1, further comprising a sensor that is arranged upstream of the second antenna in the direction of conveyance of the paper sheet, the sensor configured to sense an end of the paper sheet, wherein
when the sensor senses the end of the paper sheet and the paper sheet is conveyed by the platen a second given distance after the sensor senses the end of the paper sheet, the identification information transmitter is configured to transmit the signal containing the tag identification information.

13. The printer according to claim 1, further comprising a cutter configured to cut the paper sheet on which the information has been printed by the print head.

14. The printer according to claim 1, further comprising a selector configured to select either the first antenna or the second antenna.

15. An information writing method that is a method of writing information in a radio tag in a printer including:
a platen configured to convey a paper sheet in which the radio tag is embedded;
a print head configured to print information on the paper sheet;
a first antenna that is arranged upstream of the print head in a direction of conveyance of the paper sheet, the first antenna configured to write information in the radio tag; and
a second antenna that is arranged upstream of the first antenna in the direction of conveyance of the paper sheet, the second antenna configured to write information in the radio tag;
the method comprising:
a first transmission including transmitting a signal using the second antenna to the radio tag, the signal containing tag identification information for discriminating the radio tag from another radio tag; and
a second transmission including transmitting a signal using the first antenna to the radio tag to which the signal including the tag identification information has been transmitted by the first transmission, the signal containing the tag identification information and writing information.

16. The information writing method according to claim 15, wherein the first transmission includes transmitting, as the tag identification information, increment information for identifying the radio tag individually.

17. The information writing method according to claim 15, wherein the second transmission includes specifying the radio tag with the tag identification information and transmitting the writing information to the radio tag using the first antenna.

18. The information writing method according to claim 15, further comprising printing, by using the print head, information on the paper sheet in which the radio tag is embedded, after transmitting the writing information to the radio tag using the first antenna.

19. The information writing method according to claim 16, wherein the second transmission includes reading a piece of increment information stored in the radio tag, reading a piece of writing information associated with the read piece of increment information from the storage, and transmitting the read piece of writing information.

20. The information writing method according to claim 15, wherein the printer further includes a sensor that is arranged upstream of the second antenna in the direction of conveyance of the paper sheet, the sensor configured to sense an end of the paper sheet, and
the first transmission includes transmitting the signal containing the tag identification information when the sensor senses the end of the paper sheet and the paper sheet is conveyed by the platen a second given distance after the sensor senses the end of the paper sheet.
